(19) United States
(12) Patent Application Publication
(10) Pub. No.: US 2007/0288869 A1
(43) Pub. Date: Dec. 13, 2007

(54) LASER MARKING USER INTERFACE

(75) Inventors: KEVIN FRANKLIN, San Diego, CA (US); Patricia Anne Destefano, Groveland, MA (US); Steven Meyer, San Diego, CA (US); Shlomo Assa, Carlsbad, CA (US)

Correspondence Address: FISH & RICHARDSON, PC, P.O. BOX 1022, MINNEAPOLIS, MN, 55440-1022, US

(73) Assignee: Markem Corporation, a New Hampsire corporation

(21) Appl. No.: 11/743,117

(22) Filed: May 1, 2007

Related U.S. Application Data
(62) Division of application No. 10/890,069, filed on Jul. 12, 2004, now abandoned.

(51) Int. Cl. G06F 3/048; G06T 11/00

(52) U.S. Cl. 715/840; 345/467

(57) ABSTRACT

A laser printing system includes a computer, a user interface device, laser electronics and a laser. A first software application at the computer creates and edits fonts. The computer sends the fonts to the laser electronics, and the laser electronics use the fonts to convert text data to images for the laser to print. A second application at the computer creates and edits menu screen bitmaps. The computer sends the menu screen bitmaps to the user interface device to display. A third application at the computer creates and edits a keyboard function map for the user interface device. The computer sends the keyboard function map to the user interface device. The user interface device allows a user to edit images for the laser to print and control operation of the laser.

### BACKGROUND

Modern production practices often involve printing an identification code on commercial products. These codes are easily observed on common products such as soda cans, cosmetics, pet food containers, etc. Some government regulatory agencies, such as the Food and Drug Administration, may require certain products to have such codes.

These codes often include information that is unique to the time and place at which the product is manufactured. For instance, many codes communicate a batch number associated with a product. Many codes go further and indicate the actual time and date of manufacture. Because some codes relate to unique manufacturing parameters (e.g., time and date), some codes cannot be pre-printed on a label for a product. Hence, a code is often printed on the label after the product is manufactured. Current code printing technology includes the use of ink jets, which spray ink onto the label.

### SUMMARY

A laser printing system capable of printing an image of symbols, characters or logos on a product or product container may include a computer system, such as a personal computer (PC), a user interface device, laser electronics and a laser. A first software application at a computer creates and edits fonts. The computer sends the fonts to the laser electronics, and the laser electronics use the fonts to convert text data to images for the laser to print. A second application at the computer creates and edits menu screen bitmaps. The computer sends the menu screen bitmaps to the user interface device to display. A third application at the computer creates and edits a keyboard function map for the user interface device. The computer sends the keyboard function map to the user interface device. A user may use the user interface device to edit images for the laser to print and control operation of the laser.

In one aspect, a method of configuring a user interface device coupled to a laser for marking products includes creating a screen bitmap at a computer; sending the screen bitmap from the computer to the user interface device; and configuring the user interface device to display the screen bitmap upon receiving a user command.

Another aspect relates to a method of setting a font for a laser to mark products. The method includes creating a font at a computer. The font controls an appearance of a set of characters. The method further includes sending the font from the computer to the laser; and using the font at the laser to convert image data to pixels to mark products.

Another aspect relates to a method of mapping a keyboard of a user interface device coupled to a laser for marking products. The method includes creating a keyboard function map at a computer; sending the keyboard function map to the user interface device; and configuring the user interface device to use the keyboard function map to respond to user actions.

Another aspect relates to a user interface device coupled to a laser for marking products. The user interface device includes a display, a menu screen bitmap, a screen processing module operable to display the menu screen bitmap on the display upon receiving a user command, a keyboard function map, and a keyboard processing module operable to use the keyboard function map to execute a pre-determined function upon receiving a user command.

The systems and techniques described herein may provide one or more advantages. For example, text, graphics, icons and logos can be included in menu screen and help screen bitmaps on the user interface device. Another potential advantage is users in various countries with various languages can use Windows®-based applications at their computers to customize menu screen and help screen bitmaps based on local requirements. Another potential advantage is the user interface does not necessarily need to store fonts. Thus, the user interface may use less processing power and memory.

Details one or more implementations are set forth in the accompanying drawings and the description below. Other features and advantages may be apparent from the description, drawings and/or claims.

### BRIEF DESCRIPTION OF THE DRAWINGS

FIG. 1A is a side view of a printing system.

FIG. 1B is a cross-section of the printing system of FIG. 1A looking down on the printing system.

FIG. 2 illustrates software modules and files of the computer, user interface and laser electronics in FIG. 1B.

FIG. 3 illustrates an example of the user interface of FIG. 1B.

FIG. 4 illustrates an example of a keyboard of the user interface.

FIG. 5 is a screenshot of a key properties dialog window for assigning functions to a key.

FIG. 6 is a screenshot of a Select Unicode dialog window.

FIG. 7A shows a Home screen displayed on the user interface of FIG. 1A.

FIG. 7B shows an icon key for the Home screen of FIG. 7A.

FIG. 8 illustrates a Confirm Run Screen that displays a selected job.

FIG. 9 illustrates a File Management Screen.

FIG. 10 illustrates a Create New Job Screen.

FIG. 11 illustrates a Change Pixel Size Screen.

FIG. 12 illustrates a Save Job Screen.

FIG. 13 illustrates a Setup Machine screen.

FIG. 14 illustrates a Setup Machine Parameters Screen.

FIG. 15 illustrates a Demo-Laser Screen.

FIG. 16 illustrates a Demo-Dwell Screen.

FIG. 17 illustrates a Laser Setup Screen.

### DETAILED DESCRIPTION

A laser printing system capable of printing an image of symbols, characters or logos on a product or product container may include a computer system, such as a personal computer (PC), a user interface device, laser electronics and a laser. A first software application at a computer creates and edits fonts. The computer sends the fonts to the laser electronics, and the laser electronics use the fonts to convert text data to images for the laser to print. A second application at the computer creates and edits menu screen bitmaps. The computer sends the menu screen bitmaps to the user interface device to display. A third application at the computer creates and edits a keyboard function map for the user interface device. The computer sends the keyboard function map to the user interface device. The user interface device allows a user to edit images for the laser to print and control operation of the laser.

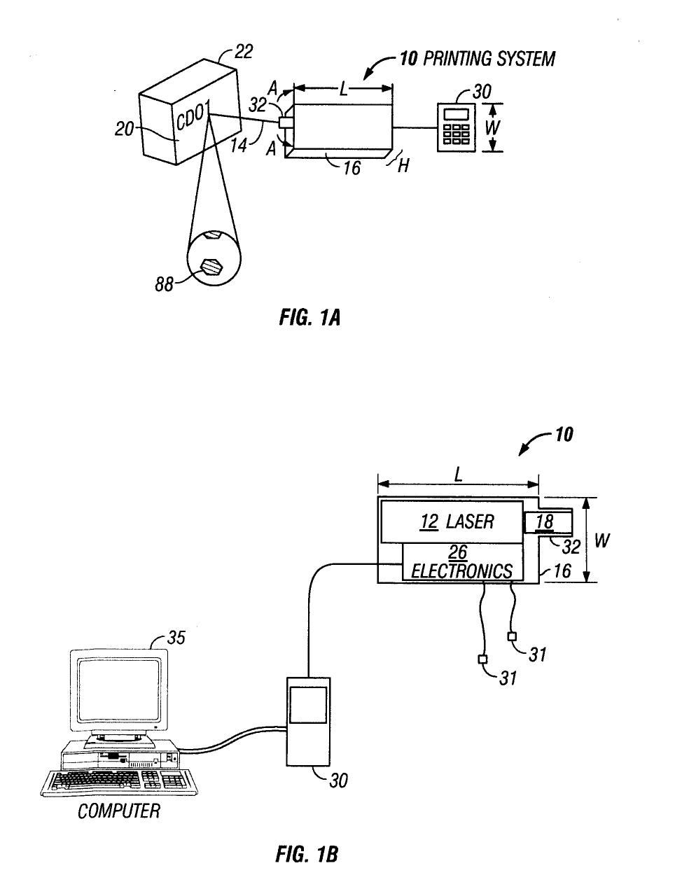

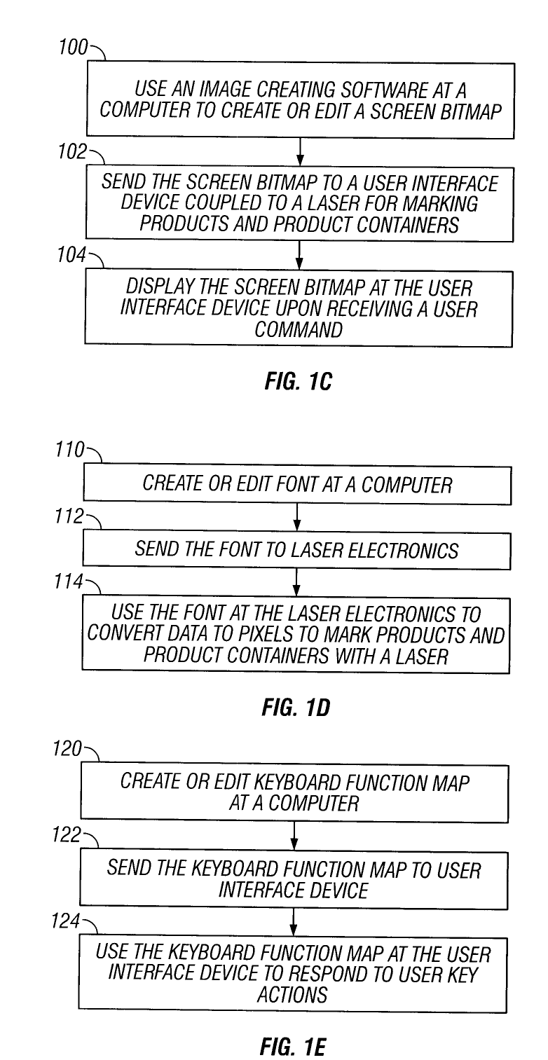

FIGS. 1A and 1B illustrate a laser printing system 10 to print or mark characters, symbols or logos on a product 22 positioned adjacent to the printing system 10. FIG. 1A is a side view of the printing system 10, and FIG. 1B is a cross sectional top view of the printing system 10. The printing system 10 may be a SmartLase™ laser system made by Markem Corporation at Keene, N.H.

The printing system 10 includes a laser 12 to produce a printing beam 14. Any suitable printing or marking laser 12 can be used in the printing system 10, such as a low powered laser. For example, the laser may be a 25-Watt laser, a 20-Watt laser, a 15-Watt laser or a 13-Watt laser. The laser 12 can be a CO₂ or Nd:YAG laser.

The printing system 10 includes an optics assembly 18 that may steer the printing beam 14 from one location to another location on the product 22. The printing system 10 includes electronics 26 (or controller) for adjusting the time that the printing beam 14 dwells at each location. This dwell time may be adjusted for the printing beam 14 to form a spot at a desired location.

The printing system 10 may print on products to be sold or the packaging material of products. Further, the products can be products that are sold to other businesses. Examples of products include pharmaceuticals, pharmaceutical packaging, food packaging, cosmetics, food such as eggs, dairy products, ice cream, computer components, automotive components, medical devices, detergents and beverages such as soft drinks and wines. The printing system 10 may print at multiple locations on a product 22. For instance, plastic medicine bottles can have one code printed directly on the plastic bottle and another code formed on the label attached to the plastic bottle.

The laser print locations can be arranged such that multiple spots form a pixel on the product. The pixels in turn can be arranged to form the symbols of a code. The symbols of the code may be available in word processing programs such as alphanumeric symbols and any other symbols used to identify a product batch, date, etc. The code can be readable text such as product names or identifiers. The code need not be alphanumeric and can include symbols other than those produced by typical word processing programs. For instance, the code can be a bar code. These symbols can be printed on a product 22 or on the label of a product 22.

Each spot is formed on the product 22 by altering an optical characteristic of the material at the location where the printing beam is incident on the product. The printing beam 14 can alter a variety of optical characteristics of a product. For instance, the printing beam 14 can cause one or more layers of material to be ablated so the underlying layers are visible. Since upper layers of a material often have an ink layer on paper, removal of the ink layer leaves a spot where the paper is visible against the surrounding ink layer. The refractive characteristics of a material can also be altered. For instance, the printing beam 14 can be used to print a code on a plastic such as a soft drink bottle. The printing beam 14 alters the refractive characteristics of the plastic. The code is easily visible since the human eye can pick up the sections having contrasting refractive properties. In addition, the printing beam can etch certain materials, such as plastic, glass, and metal.

User Interface

The printing system 10 further includes a user interface device 30 that may allow a user to control a plurality of lasers 12 and laser electronics 26. The user interface 30 may be coupled to a computer 35 (wired or wireless) as shown in FIG. 1B.

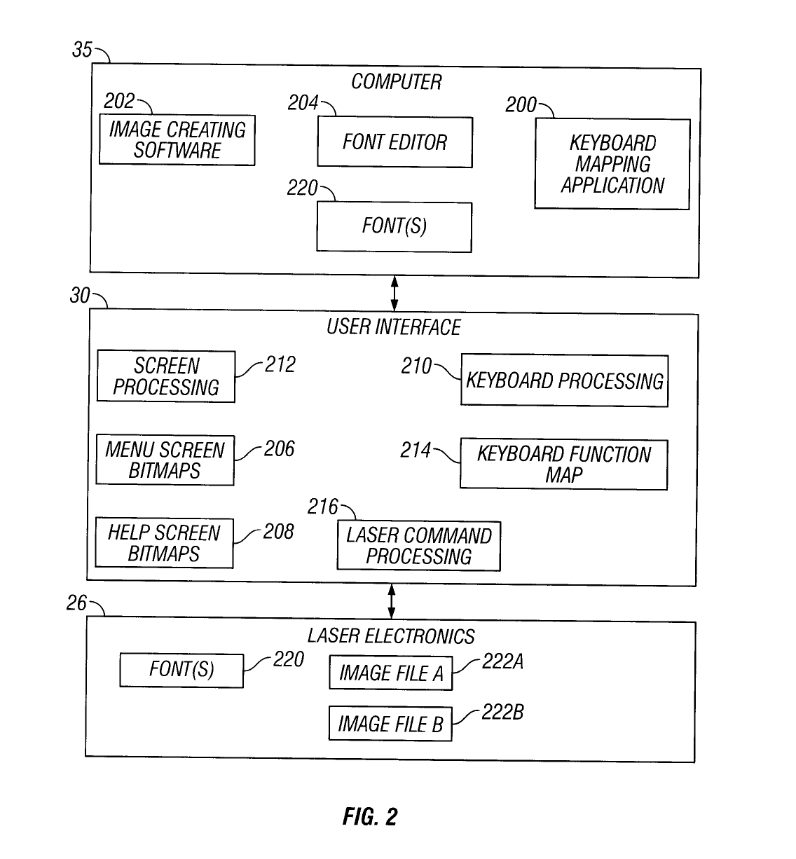

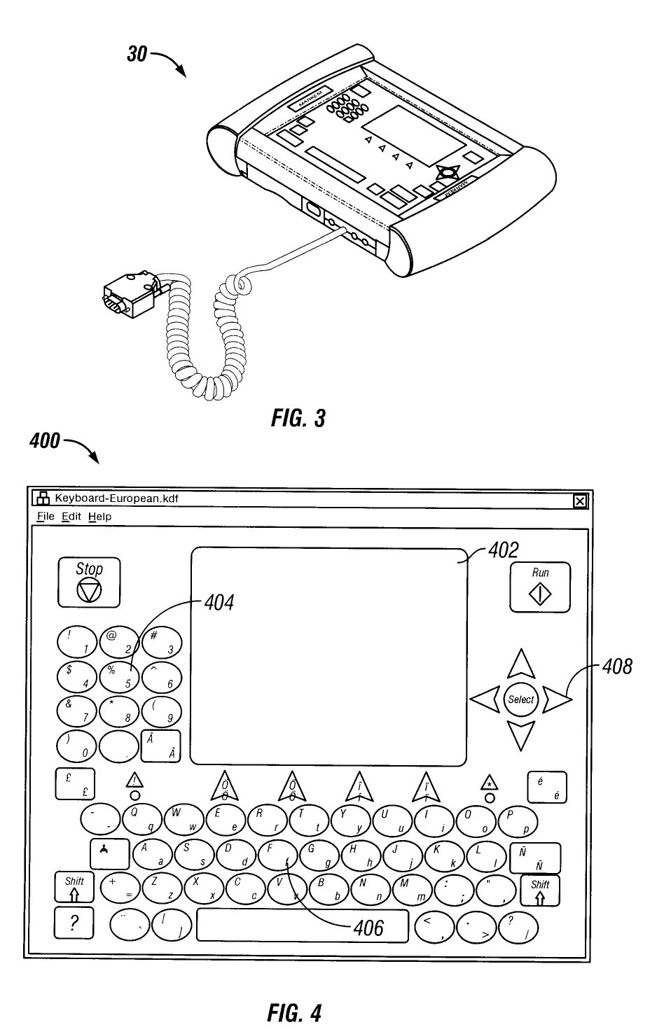

FIG. 2 illustrates software modules and files of the computer 35, user interface 30 and laser electronics 26 in FIG. 1B. FIG. 3 illustrates an example of the user interface 30 of FIG. 1B. FIG. 4 illustrates an example of a keyboard 400 of the user interface 30. The user interface 30 has a graphical display 402, such as a 320×240-pixel monochrome display.

The user interface 30 can be remote from the housing 16, attached to the housing 16 or detachable from the housing 16. The user interface 30 may be a handheld device with an alphanumeric keyboard 400 and a display 402 (FIG. 4). The user interface 30 may be implemented as a separate component or implemented with software on a general-purpose computer with no special hardware.

A user may access the user interface 30 to program the electronics 26 and/or set printing parameters. For instance, the user interface 30 can be used to manually control the time that the printing beam 14 dwells at a single location on the material 20, the size of the pixels 88 used to form a visually observable symbol, the type and/sequence of symbol which are formed, etc. The user interface 30 can also be used to manually activate the printing system 10. For instance, the user interface 30 can include a print key to cause the printing system 10 to print on the material 20.

Computer and Software

The computer 35 in FIG. 2 may backup various types of files, such as fonts, for the user interface 30 and laser electronics 26. The computer 35 may execute an image creating software application 202 (FIG. 2), a font editor 204 and a keyboard mapping application 200. The image creating software application 202 may be a Microsoft Windows® based application, such as such as Microsoft Paint™. The image creating software application 202 allows a user to create images of text and/or graphics (or import images from another source) to download to the user interface 30 to display.

The font editor 204 allows a user to create and edit fonts 220, which may be downloaded to the laser electronics 26 to store and use. A “font” specifies appearance of a set of characters to be displayed and printed. For example, a user may use the font editor 204 to create a font that specifies the appearance of over 1000 characters.

The keyboard mapping application 200 is a user interface design application that allows an administrator to create custom keyboard function maps/layouts 214 and assign specific functions to keys of the keypad 406 (FIG. 4) on the user interface 30. For example, the keyboard mapping application 200 may allow the administrator to configure which menu screen or help screen bitmap will be displayed when a certain event occurs. For example, the administrator may program the user interface 30 to display a calculator help screen bitmap if a user selects a help screen for a calculator.

The user interface 30 may store and execute menu screen bitmaps 206, help screen bitmaps 208, keyboard processing 210, screen processing 212, keyboard function map 214 and laser command processing 216.

The laser electronics 26 may store and execute fonts 220 and a plurality of image files 222A, 222B to print. Each image file 222 contains structured information. The laser electronics 26 use the image files 222A-222B and the fonts 220 to print characters and symbols. The laser electronics 26 may send an image file 222 to the user interface 30. The user interface 30 displays the image and sends user edit instructions to edit the image stored in the laser electronics 26. The laser electronics 26 edits the image and returns the edited image to the user interface 30 to display.

Alternatively, in another configuration, the user interface 30 may edit an image file at user interface 30 and send the edited image to the laser electronics 26. The user interface 30 may store backup files of the image files 222A, 222B.

FIG. 1C illustrates a method of using the image creating software 202 in FIG. 2. A user uses an image creating software 202 at a computer 35 to create a screen bitmap 206 at 100. The computer 35 sends the screen bitmap 206 to a user interface device 30 coupled to a laser 12 for marking products and product containers. The user interface device 30 displays the screen bitmap 206 upon receiving a user command. The method in FIG. 1C is described further below.

FIG. 1D illustrates a method of using the font editor 204 in FIG. 2. A user uses the font editor 204 to create or edit font 220 at a computer 35 at 110. The computer 35 sends the font 220 to laser electronics 26 at 112. The laser electronics 26 uses the font 220 to convert data to pixels to mark products and/or product containers. The method in FIG. 1D is described further below.

FIG. 1E illustrates a method of using the keyboard mapping application 200 in FIG. 2. A user uses the keyboard mapping application 200 to create or edit a keyboard function map at a computer 35 at 120. The computer 35 sends the keyboard function map 214 to a user interface device 30 at 122. The user interface device 30 uses the keyboard function map 214 to respond to user key actions at 124. The method in FIG. 1E is described further below.

Fonts and Bitmaps

The user interface 30 and the laser printing system 10 may display and print non-Roman characters, which may need one or more specially designed fonts. An example of non-Roman characters would be Asian characters, such as Chinese, Korean, Japanese, etc. Asian fonts may need thousands of high-resolution characters. Specially designed fonts, such as Asian fonts, could consume significant memory and processing resources within the laser electronics 26 and the user interface 30.

The laser electronics 26 may print fewer characters, i.e., more limited vocabulary and simpler fonts, than the user interface 30 displays. The laser 12 may be a time and date coder that prints limited text. Beyond the days of the week and months of the year, the laser 12 may print a single phrase, i.e., “Use by” or “Sell Before.” The laser 12 may print a date or lot code with no text at all. The laser 12 can use a limited font with a few hundred characters. The font may be later augmented as user requirements are identified.

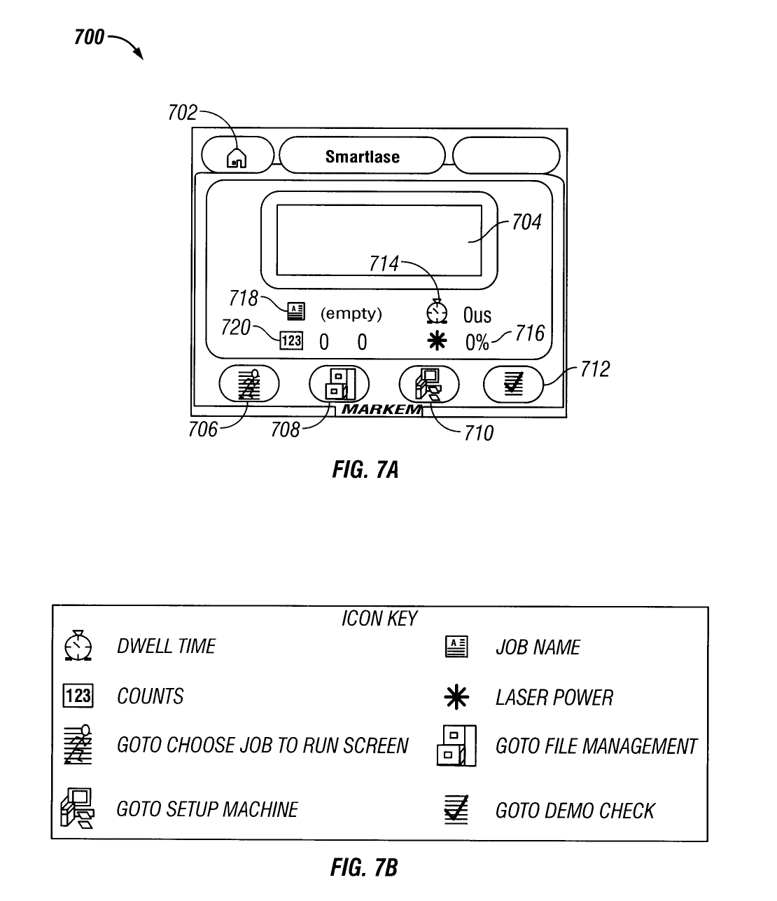

In contrast, the user interface 30 may use a much larger or more complex font with thousands of characters. The user interface 30 may interact with a user in a complex manner with a plurality of keyboard functions, menu screens and help screens. Examples of menu screens are shown in FIGS. 7A-17. The menu screens and help screens may use a significant vocabulary. The menu screens and help screens may be pre-configured and changed later by a user. When a user changes the menu screens and help screens, the vocabulary may change, and the font required may change with the vocabulary.

A menu screen may be stored as text data that is converted to pixels immediately before the menu screen is displayed. A “font” may be used to convert text data to an image for display on a user interface's display 402. But converting text data to pixels requires processing power and memory in the user interface 30 to store a font to convert the text data to pixels.

The present application recognizes that the text for each menu or help screen in the user interface 30 may be configured when the user interface 30 is manufactured. The conversion of text data to an image for display may be done anytime before a menu screen is displayed.

According to an aspect of the present application, text for menu screens and help screens are converted to pixels at the computer 35 during software development. A user may use the image creating software application 202, e.g., Microsoft Paint™, with pre-existing fonts on the computer 35 to create menu screens and help screens and store them as bitmaps 206, 208. The image creating software application 202 may also import images from another source. Examples of menu screens are shown in FIGS. 7A-17. The computer 35 uses a file transfer application to load the menu screen and help screen bitmaps 206, 208 to the user interface 30.

The user interface 30 stores and displays the menu screen bitmaps 206 and help screen bitmaps 208. The user interface 30 does not use a font to convert text and character data to an image. Thus, the user interface 30 does not have to store fonts, which would otherwise be needed to convert text data to display in menu and help screens. This saves memory and processing power at the user interface 30.

In addition, graphics, icons and logos can be included in the menu screen bitmaps 206 and help screen bitmaps 208. Existing Windows®-based applications at the computer 35 may create, edit and merge graphics with text when creating the menu screen and help screen bitmaps 206, 208. The user interface 30 displays the resulting menu screen bitmaps 206 and help screen bitmaps 208.

Another advantage is users in various countries with various languages can use Windows®-based applications at their computers 35 to customize the menu screen and help screen bitmaps 206, 208 based on their local requirements.

According to another aspect of the present application, fonts 220 are stored in the laser electronics 26. The laser electronics 26 use the fonts 220 to render text and character data in the image files 222A-222B in real-time to create lists of pixels for printing. The user interface 30 can retrieve an image (lists of pixels) from the laser electronics 26 and display them on the display 402. A user may edit the image displayed on the user interface 30. The user interface 30 sends edit commands to edit the image files 222A-222B in the laser electronics 26. By storing the fonts 220 in the laser electronics 26, images of text retrieved from the laser electronics 26 and displayed on the user interface 30 will be exactly the same as images printed by the laser 12.

Creating a Font

A user may use the font editor 204 at the computer to create and edit one or more Roman-language, Asian or other types of fonts 220. The font editor 204 may create a font with more characters than standard QWERTY keyboards. Fonts may also be loaded from other sources. The computer 35 sends the created fonts to the laser electronics via the user interface 30. The laser electronics 26 stores the fonts 220 and uses the fonts 220 to convert text data in the image files 222A-222B to printable images. The laser 12 may print a sequence of characters (called a “legend”) with the user-created font.

Mapping the User Interface Keyboard

The keyboard mapping application 200 uses the font created, loaded and/or edited by the font editor 204. The keyboard mapping application 200 allows a user to create a custom keyboard function map/layout 214 for the keypad 406 (FIG. 4) (also called keyboard) on the user interface 30. The user can control functions and characters assigned to each key on the user interface's keypad 406.

The user may choose “dead keys” and assign characters to the dead keys as part of a keyboard layout. An example of a “dead key” is the accent grave key (′) on some keyboards, which is activated when it is pressed before pressing a vowel. Characters created with the font editor 204 can replace standard QWERTY keys or be accessed through dead keys of the user's choice.

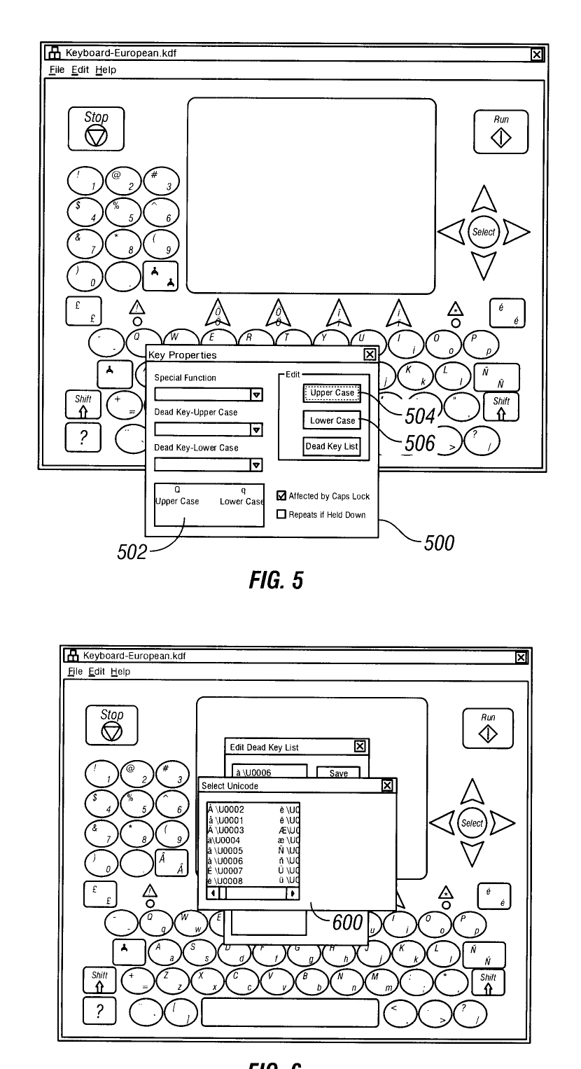

FIG. 5 is a screenshot of a key properties dialog window 500 for assigning functions to a key, which in this case is the key “Q.” The characters assigned to the key are displayed in the edit box 502. The example shows Q assigned to the shifted or Upper Case and q as the non-shifted or Lower Case. To assign different characters to the key, the user clicks on either the Upper Case or the Lower Case buttons 504, 506.

A Select Unicode dialog window 600 (FIG. 6) appears. Each character in the created font is included in the list of the Unicode dialog window 600. The character is rendered and its Unicode code point value displayed. The scroll bar across the bottom of the list is used to scroll through the font to locate the character to assign. Once the character is located, the user double clicks to assign it to the chosen shift state of the key selected.

The keyboard mapping application 200 may implement 52 Chinese characters on a Chinese user interface layout. The Chinese user interface layout may assign two Chinese characters per each Roman key, which allows the most common 52 Chinese characters to be assigned to 26 letter keys. The remaining Chinese characters may be supported using “Pinyin.” The Chinese language has phonetic names for each one of its thousands of characters. These names, referred to as “Pinyin,” consist of up to six Roman letters per character.

A common technique widely used in China and supported by Microsoft Windows® allows the operator to press a special key. A window opens, presenting a blank Pinyin window that is ready for the user to begin entering a character. The operator begins entering the Pinyin name of the desired character. As each character is entered, the list of characters displayed is narrowed down. Each letter entered moves the user further along in the list and closer to the desired entry. A digit appears above each, allowing the operator to enter that single digit to select that character. When the desired character appears, the operator presses the digit assigned to it, entering the character and closing the selection window. This functionality is similar to a Windows®-based address book.

The font editor 204 allows Pinyin names to be assigned to each created character. These names are stored in a font file 220 that is transferred to the laser electronics 26. The Pinyin selection screen displayed by the user interface 30 is implemented by the laser electronics 26 using the currently imaged font. The user interface 30 sends commands to open a screen using a specified font, and then passes successive characters and finally the digit to select the Chinese character. The Unicode for that character is returned to the user interface 30, completing the data entry. The approach described above can be applied to other Asian languages as well.

Menu Screens

FIGS. 7A-17 show examples of menu screen bitmaps 206 that may be created at the computer 35 with the image creating software 202 (FIG. 2) and loaded to the user interface 30 to store and display.

FIG. 7A shows a Home screen 700 on the user interface 30, and FIG. 7B shows an icon key for the Home screen 700. The Home menu screen 700 has a what-you-see-is-what-you-get (WYSIWYG) window 704, which displays a laser print job exactly as the laser 12 is actively printing or will print. A filename 718, laser dwell time 714, laser power 716, and number of times that the job has been printed 720 are also displayed on the Home menu screen 700. The Home menu screen 700 displays an icon 706 for a user to choose a job to run, an icon 708 to manage the files in the laser electronics 26, an icon 710 to setup the laser electronics 26 and an icon 712 to demo the laser electronics 26. Several hotkeys on the keypad 406 (FIG. 6) may also be available to the user. Shift-up/Shift-down increases and decreases the contrast. “S” activates a Laser Setup Screen.

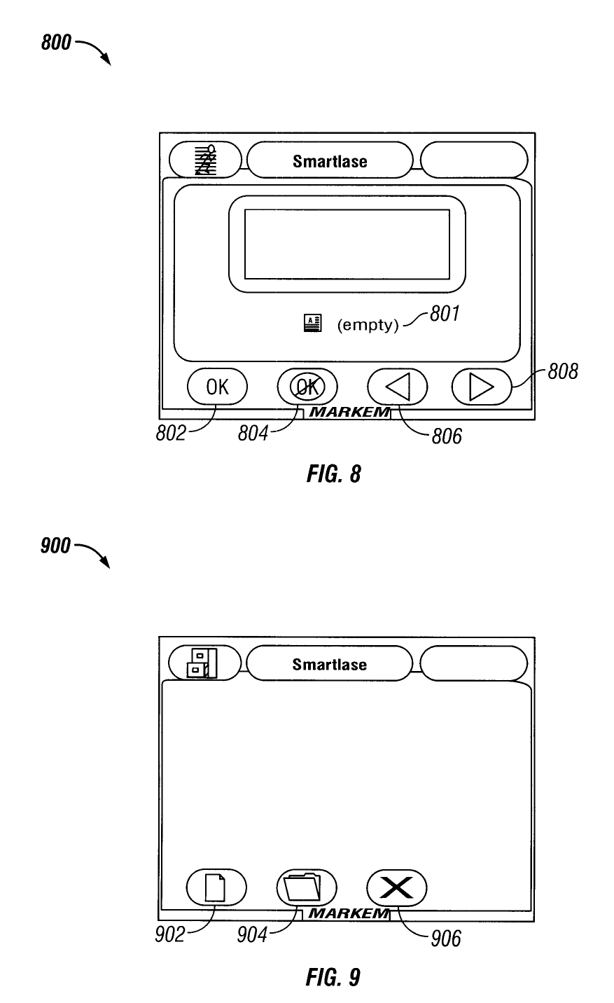

A Run Screen (not shown) displays a list of all the jobs available in the laser electronics 26 to run. The user can select a job to run. Upon selecting a job, a Confirm Run Screen 800 is activated, as shown in FIG. 8.

FIG. 8 illustrates a Confirm Run Screen 800 that displays the selected job. The filename 801 of the job is also displayed. If this is the desired job, the user hits an OK button 802 to confirm the choice. If the job is not the desired choice, the user is free to hit the next and previous arrows 808, 806 to cycle through the visual representations of the jobs available in the laser electronics 26. When the desired choice is found, the OK button 802 should be hit. If the user wants to abandon the choice, the NOT OK button 804 should be hit.

FIG. 9 illustrates a File Management Screen 900, which displays a button 902 to create a job, a button 904 to open a job, and a button 906 to delete a job.

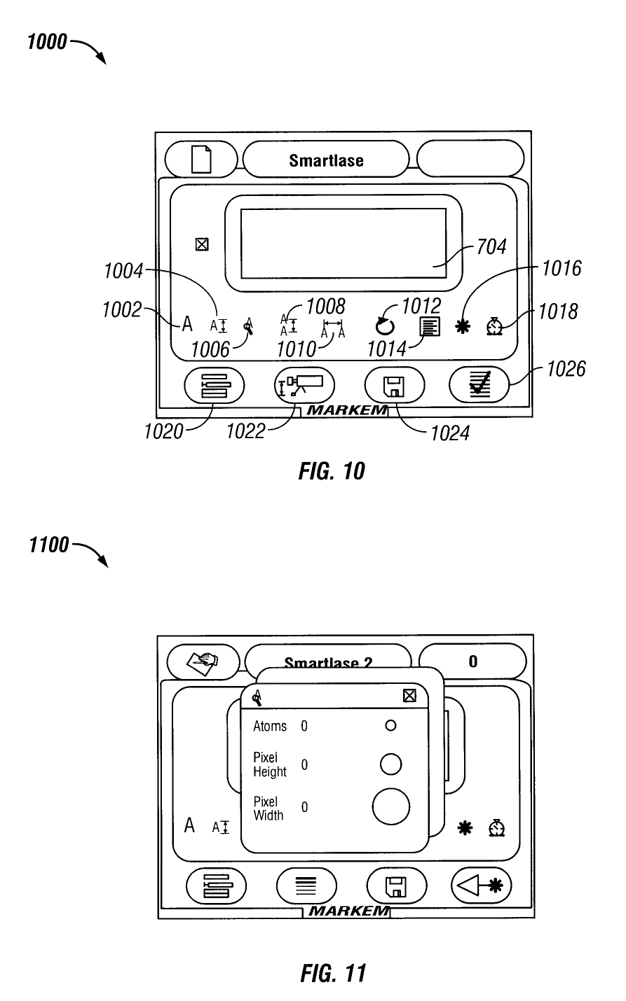

FIG. 10 illustrates a Create New Job Screen 1000, which allows the user to start with a blank slate and create a job. An Edit Job screen is similar to the Create New Job Screen 1000 and displays a job opened ready to edit. The cursors, keys, backspace, shift and carriage return on the keypad 406 (FIG. 4) can be used to create or edit the job in the WYSIWYG window 704. The screen 1000 also displays a Goto Insert dynamic Data button 1020, a Trigger Distance button 1022, a Save Job button 1024 and a Goto Demo Check button 1026. If the user wishes to change an editing property, the user hits a select to get out of the WYSIWYG mode. Then the user may use the right and left arrows 408 (FIG. 4) to highlight the property that they wish to change. These properties include: Font 1002, Character Width and Height 1004, Pixel Size 1006, Line Spacing 1008, Character Spacing 1010, Rotation 1012, Justification 1014, Laser Power 1016 and Dwell time 1018. The user may hit a select option. A pop up window for the selected property then appears, and editing for the selected property can be changed.

FIG. 11 illustrates a Change Pixel Size Screen 1100.

An Open Job Screen (not shown) allows the user to pick from a list of jobs available in the laser electronics 26. Upon selecting a job from the list, the job is loaded to edit and the user is directed to the edit job screen.

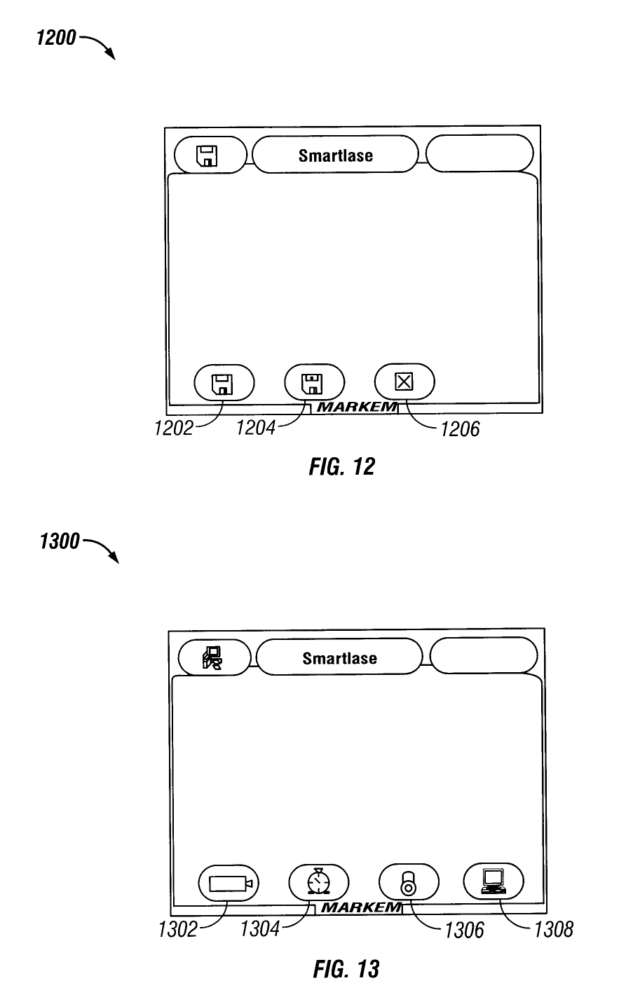

FIG. 12 illustrates a Save Job Screen 1200, which displays a button 1202 to save the created or edited job, a button 1204 to save the job under a different file name, and a button 1206 to cancel the edit. A Save As Job Screen allows a user to provide a file name to save the job just edited or cancel the edit.

FIG. 13 illustrates a Setup Machine screen 1300, which allows a user to select a Setup Machine Parameters button 1302, a Time/Date button 1304, a Security button 1306, and a System Properties button 1308.

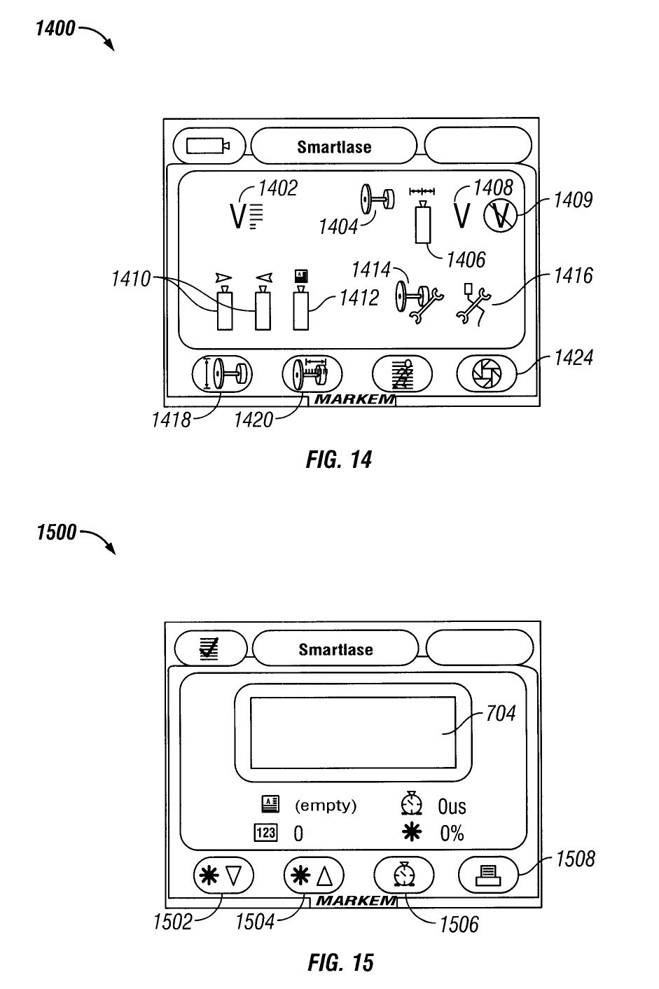

FIG. 14 illustrates a Setup Machine Parameters Screen 1400, which allows a user to set up machine parameters such as Velocity 1402, Encoder 1404, Trigger Auto 1406, Constant Velocity 1408, No Velocity 1409, Print Right and Print Left 1410, Print Static 1412, Encoder Test 1414, Trigger Test 1416, Encoder Diameter 1418, Encoder Counts 1420, and Aperture Size 1424. These parameters relate to the laser electronics 26, the laser 12 and their relationship with a product to be marked. Pop-up machine parameter screens allow the user to change each machine property. Upon selecting one of the machine properties in FIG. 14, a pop-up window for the property appears. The property can then be changed.

FIG. 15 illustrates a Demo-Laser Screen 1500, which displays a job that is selected to run in the WYSIWYG window 704. The filename, number of times that the job has been printed, dwell time, and laser power for the job are displayed on the screen 1500 as shown in FIG. 7A. From this screen 1500, the user can bump the laser power up and down with buttons 1502, 1504. The user can also print the job with button 1508 or switch to an alternate Demo-Dwell Screen with button 1506.

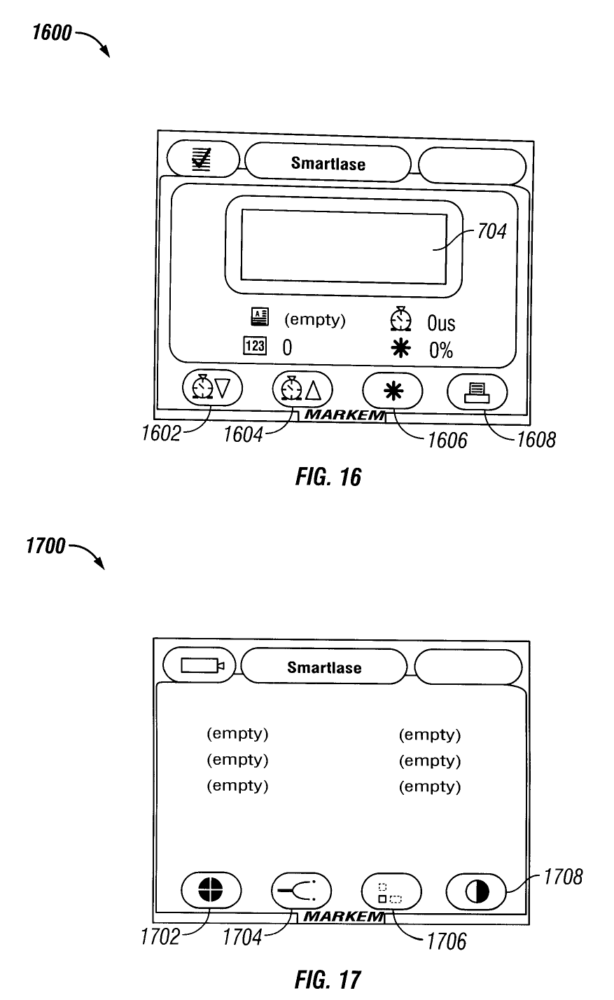

FIG. 16 illustrates a Demo-Dwell Screen 1600, which displays a job that is selected to run in the WYSIWYG window 704. From this screen 1600, the user can bump the dwell time up and down with buttons 1602, 1604. The user can also print the job with button 1608 or switch to the alternate Demo-Dwell Screen with button 1606.

FIG. 17 illustrates a Laser Setup Screen 1700, which may display version information for both the user interface and laser electronics software. The Laser Setup Screen 1700 also displays a button 1704 to tune the laser, a button 1708 to adjust the screen contrast, a button 1702 to adjust the laser aiming beam and a button 1706 to scale the laser 12. Laser Setup Pop-up Screens allow the user to adjust the Aiming Beam, Tuning Height, Tuning Dwell, Scaling Width, Scaling XY and the Screen Contrast.

Since the printing system 10 in FIG. 1A uses a laser to print on the product, there is no need for consumables such as inks and solvents. Accordingly, the printing system 10 can reduce the costs and complexity associated with printing a code on a product. Because the laser can be a low power laser, the laser, optics assembly and associated electronics can be mounted in a housing having a size on the order of an ink jet printer. As a result, the ability to adjust the dwell time means that the printing system 10 overcomes the size and space challenges associated with traditional printing systems that employ a laser. Hence, the printing system 10 is an improved substitute for ink jets used to print codes on products.

The printing system 10 may be suitable for printing on products that are moving such as the products in a production line. Because these products are moving relative to the system, there is a limited amount of time available for printing on each product. The printing system 10 includes electronics 26 for varying the amount of time to print the code on the product. For instance, the printing system 10 includes electronics for changing the density of pixels that define the code. Codes having a reduced pixel density can be printed more quickly than codes with an increased pixel density. Further, the printing system 10 includes electronics 26 for changing the size of the pixels that define the code. Smaller pixels need less printing time. In addition, the dwell time of the printing system 10 can be changed as noted above. The ability to change the time needed to print a code allows the printing system 10 to be used in conjunction with more production lines.

The printing beam 14 from the laser/energy source 12 passes through an optics assembly 18 and is incident on a material 20, such as the material used in product packaging. The time that the beam 14 is incident on the material 20 can be adjusted such that the beam 14 causes a spot to be formed on the material 20.

The optics assembly 18 includes components for altering the direction of the printing beam 14. These components can be controlled to steer the printing beam 14 from one location to another location so as to create a spot at each of the locations.

The printing system 10 also includes electronics 26 in communication with the laser/energy source 12 and the optics assembly 18. The electronics 26 can include one or more processors for providing the functionality to the printing system 10. Suitable processors include, but are not limited to, microprocessors, digital signal processors (DSP), integrated circuits, application specific integrated circuits (ASICs), logic gate arrays and switching arrays. The electronics 26 can also include one or more memories for storing instructions to be carried out by the one or more processors and/or for storing data developed during operation of the printing system 10. Suitable memories include, but are not limited to, RAM and electronic read-only memories (e.g., ROM, EPROM, or EEPROM).

The electronics 26 control the operation of the laser 12 and the optics assembly 18. For instance, the electronics 26 can control the optics assembly 18 to adjust the direction of the printing beam 14, the length of time that the printing beam 14 dwells at a location on the material 20 where a spot is to be formed, the speed that the printing beam 14 moves between each location where the beam dwells, the size of pixels 88 used to create visually recognizable symbols, the selection of symbols created, etc. The electronics 26 can be in communication with a user interface 30.

Because the laser can be a low power laser, the housing 16 can also be compact. For instance, the housing 16 can have a volume of less than 1200 cubic inches. In some instances, the housing 16 has a volume less than 900 cubic inches. In other instances, the housing 16 has a volume less than 1200 inches. In one example, the housing 16 has a length, L, less than 25 inches, a width, W, less than 10 inches and a height, H, less than 5 inches. In another example, the housing 16 has a length, L, less than 23.5 inches, a width, W, less than 7.5 inches and a height, H, less than 4 inches. For purposes of these dimensions, the housing 16 may include a print beam exit member 32, which can be moved relative to the housing as illustrated by the arrows labeled A. The printing beam exit member 32 can be rotatably moved (e.g., manually adjusted) through a continuous set of multiple directional positions to point the pulsed printing beam 14 toward a particular position on the material 170, thus allowing the pulsed printing beam 14 to be readily aimed, after the device 10 has been installed, by manipulating the printing beam exit member 32.

The small size is also associated with a low weight. For example, the housing 16 and the enclosed components may weigh less than 30 pounds. In some instances, the housing 16 and the enclosed components weigh less than 25 pounds and in other instances, the housing 16 and the enclosed components weigh less than 22 pounds. This weight does not include the weight of components that are remote from the housing 16. For instance, this weight does not include user interfaces 30 which are not integral to the housing 16. In addition, this weight does not include the weight of any sensors with which the printing system 10 is in communication but which are not integral with the housing 16.

The software described above can be used with other printing/coding systems, such as CIJ (character ink jet) systems or hot melt printing systems. Moreover, when using the systems and techniques described above with a laser printing system, graphic images can be converted into a set of locations to be marked on a product by defining progressively smaller contours of the image. Converting an image can involve identifying a set of points that trace boundary pixels of a dark area of the image such that the set of points form a contour of the dark area, removing the boundary pixels from further consideration with respect to defining the contours for the dark area, repeating the identifying and the removing until all pixels of interest in the dark area have been considered, and determining the locations from the identified points.

Identifying the set of points can involve identifying points taken from an image space of higher density than that of the image, and identifying the set of points can also involve identifying the points based on a programmable tolerance value. Removing the boundary pixels can involve removing pixels from further consideration based on a programmable contour progression factor. The pixels of interest can be defined by a programmable outline only setting. Moreover, determining the locations can involve determining the locations from the identified points based on a programmable step size.

The image can be a generated image formed from a source image based on a programmable intensity threshold. The method can also involve initially removing boundary pixels of the dark area from any consideration based on a programmable pre-erosion value. Marking the material can involve continuously directing the laser beam to the locations, in an order corresponding to the progressively smaller contours, to mark spots on the material while preventing alteration of a visible optical characteristic of the material in areas traveled by the laser beam between the spots.

Although the present application has been described in detail, it should be understood that various changes, combinations, substitutions and alterations can be made hereto without departing from the spirit and scope of the application as described by the appended claims.

1-5. (canceled)

6. A method comprising:
creating a font at a computer, the font controlling an appearance of a set of characters;
sending the font from the computer to a laser controller of a laser printing system that marks products; and
using the font at the laser controller to convert image data to pixels to mark products.

7. The method of claim 6, further comprising using the font at the laser controller to convert image data to pixels to display on a user interface device of the laser printing system.

8. The method of claim 7, wherein an image displayed on the user interface device substantially matches an image marked by the laser printing system.

9. The method of claim 6, wherein the font is an Asian font.

10-20. (canceled)

21. The method of claim 6, further comprising:
creating a screen bitmap at the computer;
sending the screen bitmap from the computer to a user interface device of the laser printing system that marks products; and
configuring the user interface device to display the screen bitmap upon receiving a user command.

22. The method of claim 21, wherein the screen bitmap corresponds to options provided for a user to control a parameter of the laser printing system to mark products.

23. The method of claim 21, wherein creating the screen bitmap comprises adding text data to the screen bitmap.

24. The method of claim 21, wherein creating the screen bitmap comprises adding graphical image data to the screen bitmap.

25. The method of claim 21, wherein creating the screen bitmap comprises adding symbol data to the screen bitmap.

26. The method of claim 21, further comprising:
creating a keyboard function map at the computer;
sending the keyboard function map to the user interface device of the laser printing system that marks products; and
configuring the user interface device to use the keyboard function map to respond to user actions.

27. The method of claim 26, wherein the keyboard function map assigns Asian characters to keys of the user interface device.

28. A software program tangibly embodied in machine-readable media, the software program comprising instructions operable to cause one or more data processing apparatus to perform operations comprising:
creating a font at a computer, the font controlling an appearance of a set of characters; and
sending the font from the computer to a laser controller of a laser printing system that marks products; wherein
the font is used at the laser controller to convert image data to pixels to mark products.

29. The software program of claim 28, wherein the font is used at the laser controller to convert image data to pixels to display on a user interface device of the laser printing system.

30. The software program of claim 29, wherein an image displayed on the user interface device substantially matches an image marked by the laser printing system.

31. The software program of claim 28, wherein the font is an Asian font.

32. The software program of claim 28, the operations comprising:
creating a screen bitmap at the computer;
sending the screen bitmap from the computer to a user interface device of the laser printing system that marks products; and
configuring the user interface device to display the screen bitmap upon receiving a user command.

33. The software program of claim 32, wherein the screen bitmap corresponds to options provided for a user to control a parameter of the laser printing system to mark products.

34. The software program of claim 32, wherein creating the screen bitmap comprises adding text data to the screen bitmap.

35. The software program of claim 32, wherein creating the screen bitmap comprises adding graphical image data to the screen bitmap.

36. The software program of claim 32, wherein creating the screen bitmap comprises adding symbol data to the screen bitmap.

37. The software program of claim 32, the operations comprising:
creating a keyboard function map at the computer;
sending the keyboard function map to the user interface device of the laser printing system that marks products; and
configuring the user interface device to use the keyboard function map to respond to user actions.

38. The software program of claim 37, wherein the keyboard function map assigns Asian characters to keys of the user interface device.

39. A laser printing system that marks products, the system comprising:
at least one laser; and
laser electronics configured to control the at least one laser to mark products;
wherein the laser electronics are configured to receive a font that controls an appearance of a set of characters, and use the font to convert text data to pixels to mark products.

40. The system of claim 39, further comprising a user interface device configured to retrieve the pixels from the laser electronics and display the pixels to a user.

41. The system of claim 40, wherein the user interface device is configured to send edit commands associated with the pixels to the laser electronics.

42. The system of claim 40, wherein the font is an Asian font.

43. The system of claim 40, wherein the user interface device comprises:
a display;
a screen processing module operable to display a screen bitmap on the display upon receiving a user command; and
a keyboard processing module operable to use a keyboard function map to execute a pre-determined function upon receiving a user command.

44. The system of claim 43, wherein the screen bitmap corresponds to options provided for a user to control a parameter of the laser printing system to mark products.

45. The system of claim 43, wherein the keyboard function map assigns Asian characters to keys of the user interface device.
